(19) United States
(12) Patent Application Publication
(10) Pub. No.: US 2015/0098769 A1
(43) Pub. Date: Apr. 9, 2015

(54) RECONFIGURABLE CUTTING TOOL

(71) Applicant: Kennametal India Limited, Bangalore (IN)

(72) Inventor: Vikram Munigala, Hyderabad (IN)

(21) Appl. No.: 14/503,642

(22) Filed: Oct. 1, 2014

(30) Foreign Application Priority Data
Oct. 4, 2013 (IN) 4514/CHE/2013

(51) Int. Cl. B23B 29/034; B23B 29/02

(52) U.S. Cl. CPC B23B 29/03489; B23B 29/02; B23B 2228/16
USPC 408/144; 76/115

(57) ABSTRACT

A reconfigurable cutting tool includes a boring head at one end, an attachment portion at a second end that is opposite the first end, and a boring bar disposed between the boring head and the attachment portion. The boring bar is made of a shape memory material such that a geometry of the reconfigurable boring tool is selectively changed in response to an activation signal from a temperature controlling processor.

### BACKGROUND OF THE INVENTION

1. Field of the Invention

The invention pertains to the field of cutting tools. More particularly, the invention pertains to a shape shifting cutting tool, such as a boring bar, and the like, with a shape memory alloy that is disposed between two non-shape shifting metals.

2. Description of Related Art

A shape-memory alloy (SMA, smart metal, memory metal, memory alloy, muscle wire, smart alloy) is an alloy that “remembers” its original, cold-forged shape: returning to the pre-deformed shape when heated. The discovery of the shape-memory effect in general dates back to 1932, when Swedish chemist Arne Ölander first observed the property in gold-cadmium alloys. The same effect was observed in Cu—Zn in the early 1950s.

The two main types of shape-memory alloys are copper-aluminium-nickel, and nickel-titanium (NiTi) alloys but SMAs can also be created by alloying zinc, copper, gold and iron. Nickel titanium, also known as Nitinol™, is a metal alloy of nickel and titanium, where the two elements are present in roughly equal atomic percentages. Nitinol™ is commercially available from NDC of Fremont, Calif. (www.nitinol.com).

The term nitinol is derived from its composition and its place of discovery: (Nickel Titanium-Naval Ordnance Laboratory). William J. Buehler along with Frederick Wang, discovered its properties during research at the Naval Ordnance Laboratory in 1958.

Nitinol alloys exhibit two closely related and unique properties: shape memory and superelasticity (also called pseudoelasticity). Shape memory refers to the ability of nitinol to undergo deformation at one temperature, then recover its original, undeformed shape upon heating above its “transformation temperature”. Superelasticity occurs at a narrow temperature range just above its transformation temperature; in this case, no heating is necessary to cause the undeformed shape to recover, and the material exhibits enormous elasticity, some 10-30 times that of ordinary metal.

Nitinol's unusual properties are derived from a reversible solid-state phase transformation known as a martensitic transformation, between two different martensite crystal phases, requiring 10,000-20,000 psi (69-140 MPa) of mechanical stress.

At high temperatures, nitinol assumes an interpenetrating primitive cubic crystal structure referred to as austenite (also known as the parent phase). At low temperatures, nitinol spontaneously transforms to a more complicated monoclinic crystal structure known as martensite (daughter phase). The temperature at which austenite transforms to martensite is generally referred to as the transformation temperature. More specifically, there are four transition temperatures. When the alloy is fully austenite, martensite begins to form as the alloy cools at the so-called martensite start, or Mₛ temperature, and the temperature at which the transformation is complete is called the martensite finish, or M_{f} temperature. When the alloy is fully martensite and is subjected to heating, austenite starts to form at the Aₛ temperature, and finishes at the A_{f} temperature.

The cooling/heating cycle shows thermal hysteresis. The hysteresis width depends on the precise nitinol composition and processing. Its typical value is around 20-50° C.

Crucial to nitinol properties are two key aspects of this phase transformation. First is that the transformation is “reversible”, meaning that heating above the transformation temperature will revert the crystal structure to the simpler austenite phase. The second key point is that the transformation in both directions is instantaneous.

Martensite's crystal structure (known as a monoclinic, or B19′ structure) has the unique ability to undergo limited deformation in some ways without breaking atomic bonds. This type of deformation is known as twinning, which consists of the rearrangement of atomic planes without causing slip, or permanent deformation. It is able to undergo about 6-8% strain in this manner. When martensite is reverted to austenite by heating, the original austenitic structure is restored, regardless of whether the martensite phase was deformed. Thus the name “shape memory” refers to the fact that the shape of the high temperature austenite phase is “remembered”, even though the alloy is severely deformed at a lower temperature.

A great deal of force can be produced by preventing the reversion of deformed martensite to austenite—from 35,000 psi to, in many cases, more than 100,000 psi (689 MPa). One of the reasons that nitinol works so hard to return its original shape is that it is not just an ordinary metal alloy, but what is known as an intermetallic compound. In an ordinary alloy, the constituents are randomly positioned on the crystal lattice; in an ordered intermetallic compound, the atoms (in this case, nickel and titanium) have very specific locations in the lattice. The fact that nitinol is an intermetallic is largely responsible for the difficulty in fabricating devices made from the alloy.

The scenario described above (cooling austenite to form martensite, deforming the martensite, then heating to revert to austenite, thus returning the original, undeformed shape) is known as the thermal shape memory effect. To fix the original “parent shape”, the alloy must be held in position and heated to about 500° C. A second effect, called superelasticity or pseudoelasticity, is also observed in nitinol. This effect is the direct result of the fact that martensite can be formed by applying a stress as well as by cooling. Thus in a certain temperature range, one can apply a stress to austenite, causing martensite to form while at the same time changing shape. In this case, as soon as the stress is removed, the nitinol will spontaneously return to its original shape. In this mode of use, nitinol behaves like a super spring, possessing an elastic range 10-30 times greater than that of a normal spring material. There are, however, constraints: the effect is only observed about 0-40° C. above the A_{f} temperature.

Nitinol is typically composed of approximately 50 to 51% nickel by atomic percent (55 to 56% weight percent). Making small changes in the composition can change the transition temperature of the alloy significantly. One can control the A_{f} temperature in nitinol to some extent, but convenient superelastic temperature ranges are from about −20° C. to +60° C.

One often-encountered complication regarding nitinol is the so-called R-phase. The R-phase is another martensitic phase that competes with the martensite phase mentioned above. Because it does not offer the large memory effects of the martensite phase, it is, more often than not, an annoyance.

There are four commonly used types of applications for nitinol:

1) Free Recovery: nitinol is deformed at a low temperature, and heated to recover its original shape.
2) Constrained Recovery: The same, except that recovery is rigidly prevented, and thus a stress is generated.
3) Work Production: Here the alloy is allowed to recover, but to do so it must act against a force (thus doing work).
4) Superelasticity: As discussed above, here the nitinol acts as a super spring.

In 1989, a survey was conducted in the United States and Canada that involved seven organizations. The survey focused on predicting the future technology, market, and applications of SMA's. The companies predicted the following uses of nitinol in a decreasing order of importance: (1) Couplings, (2) Biomedical and medical, (3) Toys, demonstration, novelty items, (4) Actuators, (5) Heat Engines, (6) Sensors, (7) Cryogenically activated die and bubble memory sockets, and finally (8) lifting devices.

Nitinol is also popular in extremely resilient glasses frames. It is also used in some mechanical watch springs. It can be used as a temperature control system; as it changes shape, it can activate a switch or a variable resistor to control the temperature. It is used in cell-phone technology as a retractable antenna, or microphone boom, due to its highly flexible and mechanical memory nature. It is used in some novelty products, such as self-bending spoons, which can be used by amateur and stage magicians to demonstrate “psychic” powers or as a practical joke, as the spoon will bend itself when used to stir tea, coffee, or any other warm liquid. It can also be used as wires which are used to locate and mark breast tumors so that following surgery can be more exact. Due to the fact it can change shapes it is also used as a golf club insert. Nickel titanium can be used to make the underwires for underwire bras.

Demonstration model heat engines have been built which use nitinol wire to produce mechanical energy from hot and cold heat sources. A prototype commercial engine developed in the 1970s by engineer Ridgway Banks at Lawrence Berkeley National Laboratory, was named the Banks Engine.

Nitinol is highly biocompatible and has properties suitable for use in orthopedic implants. Due to Nitinol's unique properties it has seen a large demand for use in less invasive medical devices. Nitinol tubing is commonly used in catheters, stents, and superelastic needles. In colorectal surgery, the material is used in devices for reconnecting the intestine after removing the pathology. In dentistry, the material is used in orthodontics for brackets and wires connecting the teeth. Suresmile is one example of an orthodontic application. Once the SMA is placed in the mouth its temperature rises to ambient body temperature. This causes the nitinol to contract back to its original shape, applying a constant force to move the teeth. These SMA wires do not need to be retightened as often as they can contract as the teeth move unlike conventional stainless steel wires. Additionally, nitinol can be used in endodontics, where nitinol files are used to clean and shape the root canals during the root canal procedure.

Another significant application of nitinol in medicine is in stents. A collapsed stent can be inserted into a vein and heated (returning to its original expanded shape) helping to improve blood flow. Also, as a replacement for sutures where nitinol wire can be weaved through two structures then allowed to transform into its preformed shape which should hold the structures in place.

During the process of manufacturing metallic or plastic components, it is common practice to have different cutting tools to manufacture even those components that have only certain minimal differences in geometry or dimension. Moreover, if a component needs to be formed into different configurations that have only minimal geometric or dimensional changes, different cutting tools are employed. As a result, a manufacturer generally must expend significant resources to accommodate the variety of cutting tools necessary to manufacture a variety of components. The resources includes not only the financial costs of stocking the various cutting tools, but also include the cases associated with changing the cutting tool between the different forming operations.

Accordingly, there is a need for a reconfigurable cutting tool that can be utilized for manufacturing different components, wherein a geometry of the reconfigurable cutting tool can be selectively altered to accommodate more than one component configuration.

### SUMMARY OF THE INVENTION

The problem of reducing the number of cutting tools necessary for manufacturing different components is solved by providing a reconfigurable cutting tool, wherein a portion of the cutting tool is made of a shape memory material in which a geometry of the reconfigurable cutting tool can be selectively changed.

In one aspect of the invention, a reconfigurable boring tool comprises a boring head at one end; an attachment portion at a second end that is opposite the first end; and a boring bar disposed between the boring head and the attachment portion, wherein the boring bar is made of a shape memory material such that a geometry of the reconfigurable boring tool is selectively changed in response to an activation signal from a temperature controlling processor.

In another aspect of the invention, a process for selectively changing a geometry of a cutting tool, comprises:
forming a boring head at one end of a boring tool;
forming an attachment portion at a second end that is opposite the first end;
forming a boring bar disposed between the boring head and the attachment portion, wherein the boring bar is made of a shape memory material; and
activating the shape memory material to selectively change a geometry of the boring tool.

### BRIEF DESCRIPTION OF THE DRAWINGS

While various embodiments of the invention are illustrated, the particular embodiments shown should not be construed to limit the claims. It is anticipated that various changes and modifications may be made without departing from the scope of this invention.

FIG. 1 is a plan view of a reconfigurable cutting tool, such as a boring tool, including a boring bar made of a shape memory material in accordance with an embodiment of the invention;

FIG. 2 is a plan view of the boring tool of FIG. 1 when the shape memory material of the boring bar is in a different state;

FIG. 3 is a flow chart of a method of controlling the reconfigurable boring tool in accordance with an embodiment of the invention.

### DETAILED DESCRIPTION OF THE INVENTION

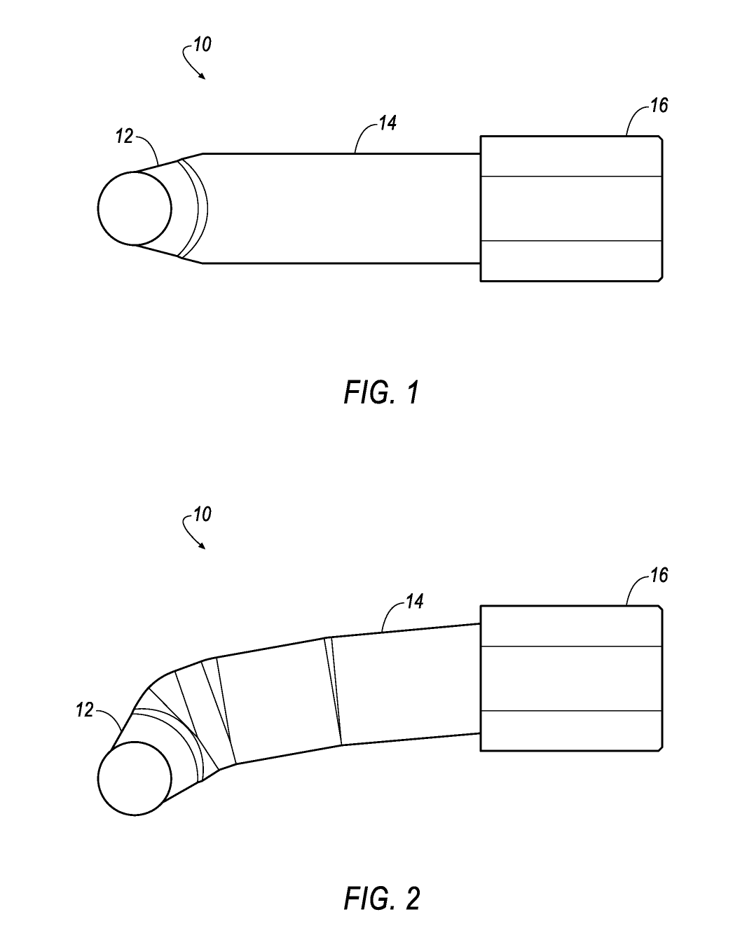

Referring now to FIGS. 1 and 2, a reconfigurable cutting tool 10 is shown according to an embodiment of the invention. In the illustrated embodiment, the cutting tool 10 comprises a boring tool. However, it will be appreciated by those skilled in the art that the principles of the invention can be applied to other types of cutting tools, such as a milling tool, turning tool, slotting tool, and the like.

Typically, a boring tool consists of two parts, the boring head and the boring bar itself. In the illustrated, the reconfigurable boring tool 10 consists of three parts; a boring head 12 at one end, a boring bar 14, and an attachment portion 16 at a second end that is opposite the first end for attaching the boring tool 10 by any suitable means known in the art. The boring head 12 is made of metal material of a type known in the art. Similarly, the attachment portion 16 can be made of the same or different metallic material as the boring head 12. However, the boring bar 14 is made of a shape memory material for effecting the reconfiguration of the boring bar 10. In operating the boring tool 10, the workpiece (not shown) may rotate while the boring tool 10 remains stationary, or the boring tool 10 may rotate while the workpiece remains stationary. The boring tool 10 is held at the second end while the boring head 12 contacts the workpiece. Thus, the boring tool 10 is overhung or cantilevered.

Suitable shape memory materials for effecting the reconfiguration of the boring tool 10 are generally those materials wherein the shape and/or modulus properties can be selectively varied by means of an activation signal. In most applications, the shape memory material is selected to provide sufficient rigidity for the desired operation. For example, an insert formed of the shape memory material for use with standard tools and dies should have sufficient rigidity to impress a desired attribute to a part and/or component processed therein. For springs, it is desired that the modulus and/or shape dimension can be selectively varied to provide the desired movement. Optionally, it may be desired to supplement the shape memory spring with a biasing and/or support spring formed of a traditional material (i.e., no shape memory) to compensate for the forces exerted on the shape memory spring, if desired.

Suitable shape memory materials include, but are not intended to be limited to, shape memory alloys (SMA), shape memory polymers (SMP), electroactive polymers (EAP), ferromagnetic SMAs, magnetic SMAs, electrorheological fluids (ER), magnetorheological fluids (MR), dielectric elastomers, ionic polymer metal composites (IPMC), piezoelectrics, piezoceramics, various combinations of the foregoing materials, and the like. Although some of the above noted shape memory materials might not be suitable for some applications noted in the various embodiments disclosed herein, combinations of the various shape materials with these materials could be made to obtain the desired outcome. For example, MR fluids can be employed in combination with a shape memory spring to provide varying degrees of translation, wherein selectively activating the MR fluid locks a dimension of the spring, for example.

As previously discussed, some shape memory materials can exhibit a one-way shape memory effect, an intrinsic two-way effect, or an extrinsic two-way shape memory effect depending on the alloy composition and processing history. For example, annealed shape memory alloys typically only exhibit the one-way shape memory effect. Sufficient heating subsequent to low-temperature deformation of the shape memory material will induce the martensite to austenite type transition, and the material will recover the original, annealed shape. Hence, one-way shape memory effects are only observed upon heating. Shape memory materials comprising shape memory alloy compositions that exhibit one-way memory effects do not automatically reform, and will likely require an external mechanical force to reform the previous shape, if desired for the particular application.

Using shape memory alloys as an example, intrinsic and extrinsic two-way shape memory materials are characterized by a shape transition both upon heating from the martensite phase to the austenite phase, as well as an additional shape transition upon cooling from the austenite phase back to the martensite phase. Shape memory materials that exhibit an intrinsic shape memory effect can be fabricated from a shape memory alloy composition that will cause the shape memory materials to automatically reform themselves as a result of the above noted phase transformations. Intrinsic two-way shape memory behavior must be induced in the shape memory material through processing. Such procedures include extreme deformation of the material while in the martensite phase, heating-cooling under constraint or load, or surface modification such as laser annealing, polishing, or shot-peening. Once the material has been trained to exhibit the two-way shape memory effect, the shape change between the low and high temperature states is generally reversible and persists through a high number of thermal cycles. In contrast, shape memory materials that exhibit the extrinsic two-way shape memory effects are composite or multi-component materials that combine a shape memory alloy composition that exhibits a one-way effect with another element that provides a restoring force to reform the original shape.

Shape memory alloys are alloy compositions with at least two different temperature-dependent phases. The most commonly utilized of these phases are the so-called martensite and austenite phases. In the following discussion, the martensite phase generally refers to the more deformable, lower temperature phase whereas the austenite phase generally refers to the more rigid, higher temperature phase. When the shape memory alloy is in the martensite phase and is heated, it begins to change into the austenite phase. The temperature at which this phenomenon starts is often referred to as austenite start temperature (Aₛ). The temperature at which this phenomenon is complete is called the austenite finish temperature (A_{f}). When the shape memory alloy is in the austenite phase and is cooled, it begins to change into the martensite phase, and the temperature at which this phenomenon starts is referred to as the martensite start temperature (Mₛ). The temperature at which austenite finishes transforming to martensite is called the martensite finish temperature (M_{f}). It should be noted that the above-mentioned transition temperatures are functions of the stress experienced by the SMA sample. Specifically, these temperatures increase with increasing stress. In view of the foregoing properties, deformation of the shape memory alloy is preferably at or below the austenite transition temperature (at or below Aₛ). Subsequent heating above the austenite transition temperature causes the deformed shape memory material sample to revert back to its permanent shape. Thus, a suitable activation signal for use with shape memory alloys is a thermal activation signal having a magnitude that is sufficient to cause transformations between the martensite and austenite phases.

The temperature at which the shape memory alloy remembers its high temperature form when heated can be adjusted by slight changes in the composition of the alloy and through thermo-mechanical processing. In nickel-titanium shape memory alloys, for example, it can be changed from above about 100° C. to below about −100° C. The shape recovery process can occur over a range of just a few degrees or exhibit a more gradual recovery. The start or finish of the transformation can be controlled to within a degree or two depending on the desired application and alloy composition. The mechanical properties of the shape memory alloy vary greatly over the temperature range spanning their transformation, typically providing shape memory effect, superelastic effect, and high damping capacity. For example, in the martensite phase a lower elastic modulus than in the austenite phase is observed. Shape memory alloys in the martensite phase can undergo large deformations by realigning the crystal structure rearrangement with the applied stress, e.g., pressure from a matching pressure foot. As will be described in greater detail below, the material will retain this shape after the stress is removed.

Suitable shape memory alloy materials include, but are not intended to be limited to, nickel-titanium based alloys, indium-titanium based alloys, nickel-aluminum based alloys, nickel-gallium based alloys, copper based alloys (e.g., copper-zinc alloys, copper-aluminum alloys, copper-gold, and copper-tin alloys), gold-cadmium based alloys, silver-cadmium based alloys, indium-cadmium based alloys, manganese-copper based alloys, iron-platinum based alloys, iron-palladium based alloys, and the like. The alloys can be binary, ternary, or any higher order so long as the alloy composition exhibits a shape memory effect, e.g., change in shape, orientation, yield strength, flexural modulus, damping capacity, superelasticity, and/or similar properties. Selection of a suitable shape memory alloy composition depends on the temperature range where the component will operate.

As noted above, shape recovery occurs when the shape memory alloy SMA undergoes deformation while in the malleable low-temperature phase and then encounters heat greater than transformation temperature (i.e., austenite finish temperature). Recovery pressures can exceed 400 megapascals (60,000 psi). Recoverable strain is as much as about 8% (about 4% to about 5% for the copper alloys) for a single recovery cycle and generally drops as the number of cycles increases.

Shape memory polymer generally refers to a polymeric material, which exhibits a change in a property, such as an elastic modulus, a shape, a dimension, a shape orientation, or a combination comprising at least one of the foregoing properties upon application of a thermal activation signal.

Generally, SMPs are phase segregated co-polymers comprising at least two different units, which may be described as defining different segments within the SMP, each segment contributing differently to the overall properties of the SMP. As used herein, the term “segment” refers to a block, graft, or sequence of the same or similar monomer or oligomer units, which are copolymerized to form the SMP. Each segment may be crystalline or amorphous and will have a corresponding melting point or glass transition temperature (Tg), respectively. The term “thermal transition temperature” is used herein for convenience to generically refer to either a Tg or a melting point depending on whether the segment is an amorphous segment or a crystalline segment. For SMPs comprising (n) segments, the SMP is said to have a hard segment and (n−1) soft segments, wherein the hard segment has a higher thermal transition temperature than any soft segment. Thus, the SMP has (n) thermal transition temperatures. The thermal transition temperature of the hard segment is termed the “last transition temperature”, and the lowest thermal transition temperature of the so-called “softest” segment is termed the “first transition temperature”. It is important to note that if the SMP has multiple segments characterized by the same thermal transition temperature, which is also the last transition temperature, then the SMP is said to have multiple hard segments.

When the SMP is heated above the last transition temperature, the SMP material can be shaped. A permanent shape for the SMP can be set or memorized by subsequently cooling the SMP below that temperature. As used herein, the terms “original shape”, “previously defined shape”, and “permanent shape” are synonymous and are intended to be used interchangeably. A temporary shape can be set by heating the material to a temperature higher than a thermal transition temperature of any soft segment yet below the last transition temperature, applying an external stress or load to deform the SMP, and then cooling below the particular thermal transition temperature of the soft segment while maintaining the deforming external stress or load.

The permanent shape can be recovered by heating the material, with the stress or load removed, above the particular thermal transition temperature of the soft segment yet below the last transition temperature. Thus, it should be clear that by combining multiple soft segments it is possible to demonstrate multiple temporary shapes and with multiple hard segments it may be possible to demonstrate multiple permanent shapes. Similarly using a layered or composite approach, a combination of multiple SMPs will demonstrate transitions between multiple temporary and permanent shapes.

For SMPs with only two segments, the temporary shape of the shape memory polymer is set at the first transition temperature, followed by cooling of the SMP, while under load, to lock in the temporary shape. The temporary shape is maintained as long as the SMP remains below the first transition temperature. The permanent shape is regained when the SMP is once again brought above the first transition temperature with the load removed. Repeating the heating, shaping, and cooling steps can repeatedly reset the temporary shape.

Most SMPs exhibit a “one-way” effect, wherein the SMP exhibits one permanent shape. Upon heating the shape memory polymer above a soft segment thermal transition temperature without a stress or load, the permanent shape is achieved and the shape will not revert back to the temporary shape without the use of outside forces.

As an alternative, some shape memory polymer compositions can be prepared to exhibit a “two-way” effect, wherein the SMP exhibits two permanent shapes. These systems include at least two polymer components. For example, one component could be a first cross-linked polymer while the other component is a different cross-linked polymer. The components are combined by layer techniques, or are interpenetrating networks, wherein the two polymer components are cross-linked but not to each other. By changing the temperature, the shape memory polymer changes its shape in the direction of a first permanent shape or a second permanent shape. Each of the permanent shapes belongs to one component of the SMP. The temperature dependence of the overall shape is caused by the fact that the mechanical properties of one component (“component A”) are almost independent from the temperature in the temperature interval of interest. The mechanical properties of the other component (“component B”) are temperature dependent in the temperature interval of interest. In one embodiment, component B becomes stronger at low temperatures compared to component A, while component A is stronger at high temperatures and determines the actual shape. A two-way memory device can be prepared by setting the permanent shape of component A (“first permanent shape”), deforming the device into the permanent shape of component B (“second permanent shape”), and fixing the permanent shape of component B while applying a stress.

It should be recognized by one of ordinary skill in the art that it is possible to configure SMPs in many different forms and shapes. Engineering the composition and structure of the polymer itself can allow for the choice of a particular temperature for a desired application. For example, depending on the particular application, the last transition temperature may be about 0° C. to about 300° C. or above. A temperature for shape recovery (i.e., a soft segment thermal transition temperature) may be greater than or equal to about −30° C. Another temperature for shape recovery may be greater than or equal to about 40° C. Another temperature for shape recovery may be greater than or equal to about 100° C. Another temperature for shape recovery may be less than or equal to about 250° C. Yet another temperature for shape recovery may be less than or equal to about 200° C. Finally, another temperature for shape recovery may be less than or equal to about 150° C.

Optionally, the SMP can be selected to provide stress-induced yielding, which may be used directly (i.e. without heating the SMP above its thermal transition temperature to ‘soften’ it) to make it conform to a given surface. The maximum strain that the SMP can withstand in this case can, in some embodiments, be comparable to the case when the SMP is deformed above its thermal transition temperature.

Suitable shape memory polymers can be thermoplastics, thermosets, interpenetrating networks, semi-interpenetrating networks, or mixed networks. The polymers can be a single polymer or a blend of polymers. The polymers can be linear or branched thermoplastic elastomers with side chains or dendritic structural elements. Suitable polymer components to form a shape memory polymer include, but are not limited to, polyphosphazenes, poly(vinyl alcohols), polyamides, polyester amides, poly(amino acid)s, polyanhydrides, polycarbonates, polyacrylates, polyalkylenes, polyacrylamides, polyalkylene glycols, polyalkylene oxides, polyalkylene terephthalates, polyortho esters, polyvinyl ethers, polyvinyl esters, polyvinyl halides, polyesters, polylactides, polyglycolides, polysiloxanes, polyurethanes, polyethers, polyether amides, polyether esters, and copolymers thereof. Examples of suitable polyacrylates include poly(methyl methaciylate), poly(ethyl methacrylate), poly(butyl methacrylate), poly(isobutyl methacrylate), poly(hexyl methacrylate), poly(isodecyl methacrylate), poly(lauryl mnethacrylate), poly(phenyl methacrylate), poly(methyl acrylate), poly(isopropyl acrylate), poly(isobutyl acrylate) and poly(octadecylacrylate). Examples of other suitable polymers include polystyrene, polypropylene, polyvinyl phenol, polyvinylpyrrolidone, chlorinated polybutylene, poly(octadecyl vinyl ether), ethylene vinyl acetate, polyethylene, poly(ethylene oxide)-poly(ethylene terephthalate), polyethylene/nylon (graft copolymer), polycaprolactones-polyamide (block copolymer), poly(caprolactone) diniethacrylate-n-butyl acrylate, poly(norbornyl-polyhedral oligomeric silsequioxane), polyvinylchloride, urethane/butadiene copolymers, polyurethane block copolymers, styrene-butadienestyrene block copolymers, and the like. The polymer(s) used to form the various segments in the SMPs described above are either commercially available or can be synthesized using routine chemistry. Those of skill in the art can readily prepare the polymers using known chemistry and processing techniques without undue experimentation.

The shape memory material may also comprise an electroactive polymer—two classes of which are electronic and ionic EAP's (electroactive polymers)—examples of which include ionic polymer metal composites, conductive polymers, piezoelectric material, and the like.

Electroactive polymers include those polymeric materials that exhibit piezoelectric, pyroelectric, or electrostrictive properties in response to electrical or mechanical fields. The materials generally employ the use of compliant electrodes that enable polymer films to expand or contract in the in-plane directions in response to applied electric fields or mechanical stresses. An example of an electrostrictive-grafted elastomer with a piezoelectric poly(vinylidene fluoride-trifluoro-ethylene) copolymer. This combination has the ability to produce a varied amount of ferroelectric-electrostrictive molecular composite systems. These may be operated as a piezoelectric sensor or even an electrostrictive actuator.

Materials suitable for use as an electroactive polymer may include any substantially insulating polymer or rubber (or combination thereof) that deforms in response to an electrostatic force or whose deformation results in a change in electric field. Exemplary materials suitable for use as a pre-strained polymer include silicone elastomers, acrylic elastomers, polyurethanes, thermoplastic elastomers, copolymers comprising PVDF, pressure-sensitive adhesives, fluoroelastomers, polymers comprising silicone and acrylic moieties, and the like. Polymers comprising silicone and acrylic moieties may include copolymers comprising silicone and acrylic moieties, polymer blends comprising a silicone elastomer and an acrylic elastomer, for example.

Materials used as an electroactive polymer may be selected based on one or more material properties such as a high electrical breakdown strength, a low modulus of elasticity (for large or small deformations), a high dielectric constant, and the like. In one embodiment, the polymer is selected such that is has an elastic modulus at most about 100 MPa. In another embodiment, the polymer is selected such that is has a maximum actuation pressure between about 0.05 MPa and about 10 MPa, and preferably between about 0.3 MPa and about 3 MPa. In another embodiment, the polymer is selected such that is has a dielectric constant between about 2 and about 20, and preferably between about 2.5 and about 12. The present disclosure is not intended to be limited to these ranges. Ideally, materials with a higher dielectric constant than the ranges given above would be desirable if the materials had both a high dielectric constant and a high dielectric strength. In many cases, electroactive polymers may be fabricated and implemented as thin films. Thicknesses suitable for these thin films may be below 50 micrometers.

As electroactive polymers may deflect at high strains, electrodes attached to the polymers should also deflect without compromising mechanical or electrical performance. Generally, electrodes suitable for use may be of any shape and material provided that they are able to supply a suitable voltage to, or receive a suitable voltage from, an electroactive polymer. The voltage may be either constant or varying over time. In one embodiment, the electrodes adhere to a surface of the polymer. Electrodes adhering to the polymer are preferably compliant and conform to the changing shape of the polymer. Correspondingly, the present disclosure may include compliant electrodes that conform to the shape of an electroactive polymer to which they are attached. The electrodes may be only applied to a portion of an electroactive polymer and define an active area according to their geometry. Various types of electrodes suitable for use with the present disclosure include structured electrodes comprising metal traces and charge distribution layers, textured electrodes comprising varying out of plane dimensions, conductive greases such as carbon greases or silver greases, colloidal suspensions, high aspect ratio conductive materials such as carbon fibrils and carbon nanotubes, and mixtures of ionically conductive materials.

Materials used for electrodes of the present disclosure may vary. Suitable materials used in an electrode may include graphite, carbon black, colloidal suspensions, thin metals including silver and gold, silver filled and carbon filled gels and polymers, and ionically or electronically conductive polymers. It is understood that certain electrode materials may work well with particular polymers and may not work as well for others. By way of example, carbon fibrils work well with acrylic elastomer polymers while not as well with silicone polymers.

As used herein, the term “piezoelectric” is used to describe a material that mechanically deforms when a voltage potential is applied, or conversely, generates an electrical charge when mechanically deformed. Preferably, the piezoelectric material is disposed on strips of a flexible metal or ceramic sheet. The strips can be unimorph or bimorph. Preferably, the strips are bimorph, because bimorphs generally exhibit more displacement than unimorphs.

One type of unimorph is a structure composed of a single piezoelectric element externally bonded to a flexible metal foil or strip, which is stimulated by the piezoelectric element when activated with a changing voltage and results in an axial buckling or deflection as it opposes the movement of the piezoelectric element. The actuator movement for a unimorph can be by contraction or expansion. Unimorphs can exhibit a strain of as high as about 10%, but generally can only sustain low loads relative to the overall dimensions of the unimorph structure.

In contrast to the unimorph piezoelectric device, a bimorph device includes an intermediate flexible metal foil sandwiched between two piezoelectric elements. Bimorphs exhibit more displacement than unimorphs because under the applied voltage one ceramic element will contract while the other expands. Bimorphs can exhibit strains up to about 20%, but similar to unimorphs, generally cannot sustain high loads relative to the overall dimensions of the unimorph structure.

Suitable piezoelectric materials include inorganic compounds, organic compounds, and metals. With regard to organic materials, all of the polymeric materials with non-centrosymmetric structure and large dipole moment group(s) on the main chain or on the side-chain, or on both chains within the molecules, can be used as candidates for the piezoelectric film. Examples of suitable polymers include, for example, but are not limited to, poly(sodium 4-styrenesulfonate) (“PSS”), poly S-(poly(vinylamine)backbone azo chromophore), and their derivatives; polyfluorocarbons, including polyvinylidene fluoride (“PVDF”), its co-polymer vinylidene fluoride (“VDF”), trifluoroethylene (TrFE), and their derivatives; polychlorocarbons, including poly(vinyl chloride) (“PVC”), polyvinylidene chloride (“PVC2”), and their derivatives; polyacrylonitriles (“PAN”), and their derivatives; polycarboxylic acids, including poly(methacrylic acid (“PMA”), and their derivatives; polyureas, and their derivatives; polyurethanes (“PUE”), and their derivatives; bio-polymer molecules such as poly-L-lactic acids and their derivatives, and membrane proteins, as well as phosphate bio-molecules; polyanilines and their derivatives, and all of the derivatives of tetramines; polyimides, including Kapton molecules and polyetherimide (“PEI”), and their derivatives; all of the membrane polymers; poly(N-vinyl pyrrolidone) (“PVP”) homopolymer, and its derivatives, and random PVP-co-vinyl acetate (“PVAc”) copolymers; and all of the aromatic polymers with dipole moment groups in the main-chain or side-chains, or in both the main-chain and the side-chains, and mixtures thereof.

Further, piezoelectric materials can include Pt, Pd, Ni, Ti, Cr, Fe, Ag, Au, Cu, and metal alloys and mixtures thereof. These piezoelectric materials can also include, for example, metal oxide such as SiO₂, Al₂O₃, ZrO₂, TiO₂, SrTiO₃, PbTiO₃, BaTiO₃, FeO₃, Fe₃O₄, ZnO, and mixtures thereof; and Group VIA and IIB compounds, such as CdSe, CdS, GaAs, AgCaSe.sub.2, ZnSe, GaP, InP, ZnS, and mixtures thereof.

Suitable MR elastomer materials include, but are not intended to be limited to, an elastic polymer matrix comprising a suspension of ferromagnetic or paramagnetic particles, wherein the particles are described above. Suitable polymer matrices include, but are not limited to, poly-alpha-olefins, natural rubber, silicone, polybutadiene, polyethylene, polyisoprene, and the like.

Suitable shape memory materials can also comprise magnetorheological (MR) compositions, such as MR elastomers, which are known as “smart” materials whose rheological properties can rapidly change upon application of a magnetic field. MR elastomers are suspensions of micrometer-sized, magnetically polarizable particles in a thermoset elastic polymer or rubber. The stiffness of the elastomer structure is accomplished by changing the shear and compression/tension moduli by varying the strength of the applied magnetic field. The MR elastomers typically develop structure when exposed to a magnetic field in as little as a few milliseconds. Discontinuing the exposure of the MR elastomers to the magnetic field reverses the process and the elastomer returns to its lower modulus state.

FIG. 1 shows the reconfigurable boring tool 10 when the boring bar 14 made of shape memory material is in one state, while FIG. 2 shows the boring tool 10 when the reconfigurable boring bar 14 made of shape memory material is in a different state.

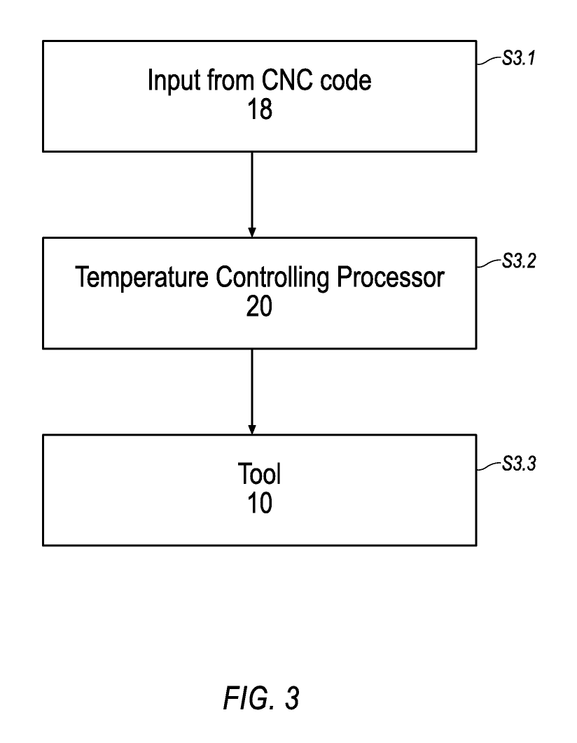

Referring now to FIG. 3, a method for controlling the reconfigurable boring tool 10 is shown. In Step S3.1, input is received from a computer numerical control (CNC) program 18. As is known in the art, modern CNC mills differ little in concept from the original model built at MIT in 1952. Mills typically consist of a table that moves in the X and Y axes, and a tool spindle that moves in the Z (depth). The position of the tool is driven by motors through a series of step-down gears in order to provide highly accurate movements, or in modern designs, direct-drive stepper motor or servo motors. Open-loop control works as long as the forces are kept small enough and speeds are not too great. On commercial metalworking machines closed loop controls are standard and required in order to provide the accuracy, speed, and repeatability demanded.

In Step S3.2, the input from the CNC program 18 is received by a temperature controlling processor 20. As mentioned above, the shape memory material is a conductor of electricity and has resistance. When electricity is passed through the shape memory material, the shape memory material is heated. The heating of the shape memory material directly depends on the amount of current passing through the material. The temperature controlling processor 20 controls the amount of current to the boring bar 14 so that the desired temperature is maintained in the shape memory material.

In Step S3.3, the temperature controlling processor 20 sends an activation signal to the shape memory material of the boring bar 14 of the boring tool 10. The activation signal may comprise a magnetic signal, a thermal signal, an electrical signal, a stress signal, and combinations comprising at least one of the foregoing activation signals. In this manner, a geometry of the reconfigurable boring tool 10 is selectively changed in response to the activation signal.

The patents and publications referred to herein are hereby incorporated by reference.

Having described presently preferred embodiments the invention may be otherwise embodied within the scope of the appended claims.

1. A reconfigurable boring tool, comprising:
a boring head at one end;
an attachment portion at a second end that is opposite the first end; and
a boring bar disposed between the boring head and the attachment portion, wherein the boring bar is made of a shape memory material such that a geometry of the reconfigurable boring tool is selectively changed in response to an activation signal from a temperature controlling processor.

2. The reconfigurable boring tool of claim 1, wherein the shape memory material comprises a shape memory polymer, a shape memory alloy, an electroactive polymer, a ferromagnetic shape memory alloy, a magnetic shape memory alloy, an electrorheological fluid; a magnetorheological fluid, a dielectric elastomer, an ionic polymer metal composites, a piezoelectric polymer, a piezoelectric ceramic, and combinations comprising at least one of the foregoing shape memory materials.

3. The reconfigurable boring tool of claim 1, wherein the activation signal comprises a magnetic signal, a thermal signal, an electrical signal, a stress signal, and combinations comprising at least one of the foregoing activation signals.

4. The reconfigurable boring tool of claim 1, wherein the shape memory material is selected to exhibit a one-way shape memory effect.

5. The reconfigurable boring tool of claim 1, wherein the shape memory material is selected to exhibit a two-way shape memory effect.

6. The reconfigurable boring tool of claim 1, wherein the shape memory material is Nitinol™.

7. A process for selectively changing a geometry of a cutting tool, comprising:
forming a boring head at one end of a boring tool;
forming an attachment portion at a second end that is opposite the first end;
forming a boring bar disposed between the boring head and the attachment portion, wherein the boring bar is made of a shape memory material; and
activating the shape memory material to selectively change a geometry of the boring tool.

8. The process of claim 7, wherein activating the shape memory material comprises delivering an activation signal from a temperature controlling processor to the boring bar.

9. The process of claim 8, wherein the activation signal comprises a magnetic signal, a thermal signal, an electrical signal, a stress signal, and combinations comprising at least one of the foregoing activation signals.

10. The process of claim 7, wherein the shape memory material is selected to exhibit a one-way shape memory effect.

11. The process of claim 7, wherein the shape memory material is selected to exhibit a two-way shape memory effect.

12. The process of claim 7, wherein the shape memory material is Nitinol™.
